(19) United States
(12) Patent Application Publication
(10) Pub. No.: US 2014/0027043 A1
(43) Pub. Date: Jan. 30, 2014

(54) ENERGY STORAGE DEVICE FABRICATION METHOD

(71) Applicants: Keh-Chi Tsai, (US); Yueh-Hsun Lee, New Taipei City (TW)

(72) Inventors: Keh-Chi Tsai, (US); Yueh-Hsun Lee, New Taipei City (TW)

(21) Appl. No.: 13/606,429

(22) Filed: Sep. 7, 2012

(30) Foreign Application Priority Data
Jul. 25, 2012 (TW) 101126834

(51) Int. Cl. B32B 37/12

(52) U.S. Cl. 156/146

(57) ABSTRACT

An energy storage device fabrication method includes the steps of: mounting a frame shell at the top wall of a first plate electrode, mounting a glue frame at the top wall of the first plate electrode around the frame shell to have the top wall of the glue frame be disposed above the elevation of top wall of the frame shell, filling an electrolyte solution in the accommodation chamber defined by the glue frame, the frame shell and the top wall of the first plate member under a vacuum environment to form a first unit, mounting a second unit with a second plate electrode at the top wall of the glue frame, and bonding the second unit to the glue frame of the first unit under a vacuum environment to seal the electrolyte solution in between the first plate electrode and the second plate electrode.

### BACKGROUND OF THE INVENTION

1. Field of the Invention

The present invention relates to energy storage device fabrication technology and more particularly, to an ultra-capacitor fabrication method.

2. Description of the Related Art

A so-called ultra-capacitor of commercial energy storage device is known comprising an electrolyte solution sealed between two plate electrodes. Subject to the principle of electrochemical double layer, charging and discharging at the interfaces between the plate electrodes and the electrolyte solution. When a voltage is applied to the two plate electrodes, electric charges will be accumulated at the interface between each plate electrode and the electrolyte solution, forming a charge layer, i.e., a charging effect occurs at this time. When the applied voltage is disconnected, the cumulative charges of the two charge layers will move toward the electrolyte solution, causing charge neutralization and releasing the energy.

The aforementioned ultra-capacitor not only solve the drawbacks of low energy-storing capacity of conventional capacitors energy and the drawback of low output power of conventional batteries, and ultra-capacitor energy storage density and power are higher than conventional capacitors and batteries, very suitable for portable 3C products, composite drive or electric vehicles, and the other electronic devices configured to be used with a power source having small size and high energy density and high power characteristics.

Taiwan Patent No. 501324 discloses an ultra-capacitor fabrication method, which allows quick bonding of two plate electrodes and sealing of an electrolyte solution. However, an ultra-capacitor made according to this method may contain much air in the electrolyte solution to affect its performance, and therefore the manufacturing yield rate of this method is low. An improvement is necessary.

### SUMMARY OF THE INVENTION

The present invention has been accomplished under the circumstances in view. It is the main object of the present invention to prove an energy storage device fabrication method, which avoids a high concentration of air in the electrolyte solution of the fabricated energy storage device to affect the performance of the energy storage device, improving the energy storage device manufacturing yield rate.

To achieve this and other objects of the present invention, an energy storage device fabrication method comprises the steps of:

a) fixedly mounting a frame shell at a top wall of a first plate electrode;

b) fixedly mounting a glue frame at the top wall of the first plate electrode around the frame shell in such a manner that the distance between a top wall of the glue frame and the top wall of the first plate electrode is greater than the distance between a top wall of the frame shell and the top wall of the first plate electrode;

c) filling an electrolyte solution in an accommodation chamber defined by the glue frame, the frame shell and the top wall of the first plate member under a vacuum environment, whereby the first plate electrode, the frame shell, the glue frame and the electrolyte solution constitute a first unit;

d) mounting a second unit comprising a second plate electrode at the top wall of the glue frame; and

e) applying a pressure to the first unit and the second unit to bond the second unit to the glue frame of the first unit under a vacuum environment, and then sealing the electrolyte solution in between the first plate electrode and the second plate electrode.

Further, during step e), a part of the softened glue frame will fill up the gap between the top wall of the frame shell and the second unit, thereby bonding the frame shell and the second unit together. Further, the volume of the accommodation chamber will be reduced during step e), residual air in the accommodation chamber and excessive electrolyte solution will be discharged outside the glue frame. Thus, this energy storage device fabrication method can greatly improve the manufacturing yield rate of the energy storage device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating step a) of an energy storage device fabrication method in accordance with a first embodiment of the present invention (I). FIG. 2 is a schematic drawing illustrating step a) of the energy storage device fabrication method in accordance with the first embodiment of the present invention (II).

FIG. 3 is a schematic drawing illustrating step a) of the energy storage device fabrication method in accordance with the first embodiment of the present invention (III).

FIG. 4 is a schematic drawing illustrating step b) of the energy storage device fabrication method in accordance with the first embodiment of the present invention (I).

FIG. 5 is a schematic drawing illustrating step b) of the energy storage device fabrication method in accordance with the first embodiment of the present invention

FIG. 6 is a schematic drawing illustrating step c) of the energy storage device fabrication method in accordance with the first embodiment of the present invention (I).

FIG. 7 is a schematic drawing illustrating step c) of the energy storage device fabrication method in accordance with the first embodiment of the present invention (II).

FIG. 8 is a schematic drawing illustrating step d) of the energy storage device fabrication method in accordance with the first embodiment of the present invention.

FIG. 9 is a schematic drawing illustrating step e) of the energy storage device fabrication method in accordance with the first embodiment of the present invention (I).

FIG. 10 is a schematic drawing illustrating step e) of the energy storage device fabrication method in accordance with the first embodiment of the present invention (II).

FIG. 11 is similar to FIG. 3, illustrating step a) of an energy storage device fabrication method in accordance with a second embodiment of the present invention.

FIG. 12 is similar to FIG. 10, illustrating an energy storage device fabrication method in accordance with the second embodiment of the present invention.

FIG. 13 is similar to FIG. 8, illustrating step d) of an energy storage device fabrication method in accordance with a third embodiment of the present invention.

FIG. 14 is similar to FIG. 10, illustrating an energy storage device made in accordance with the third embodiment of the present invention.

FIG. 15 is a schematic drawing illustrating step d) of an energy storage device fabrication method in accordance with a fourth embodiment of the present invention (I).

FIG. 16 is a schematic drawing illustrating step d) of the energy storage device fabrication method in accordance with the fourth embodiment of the present invention (II).

FIG. 17 is a schematic sectional view of an energy storage device made in accordance with the fourth embodiment of the present invention.

### DETAILED DESCRIPTION OF THE INVENTION

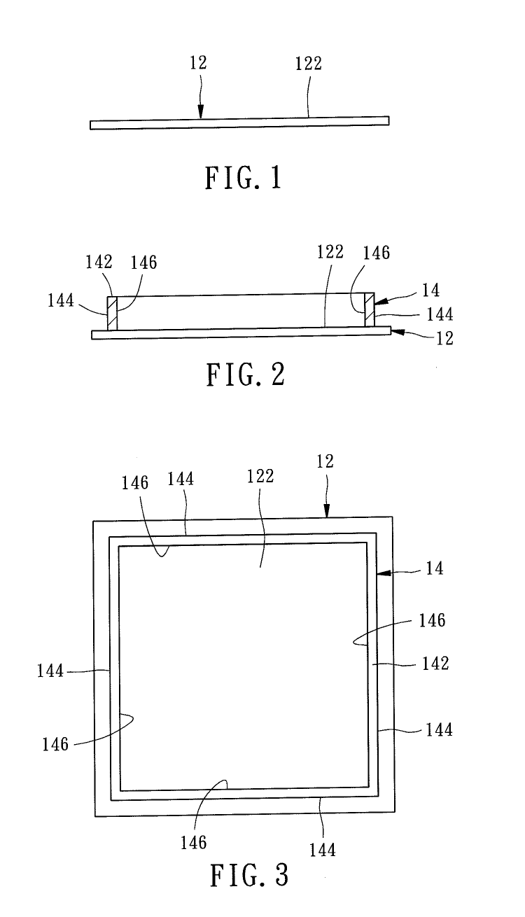

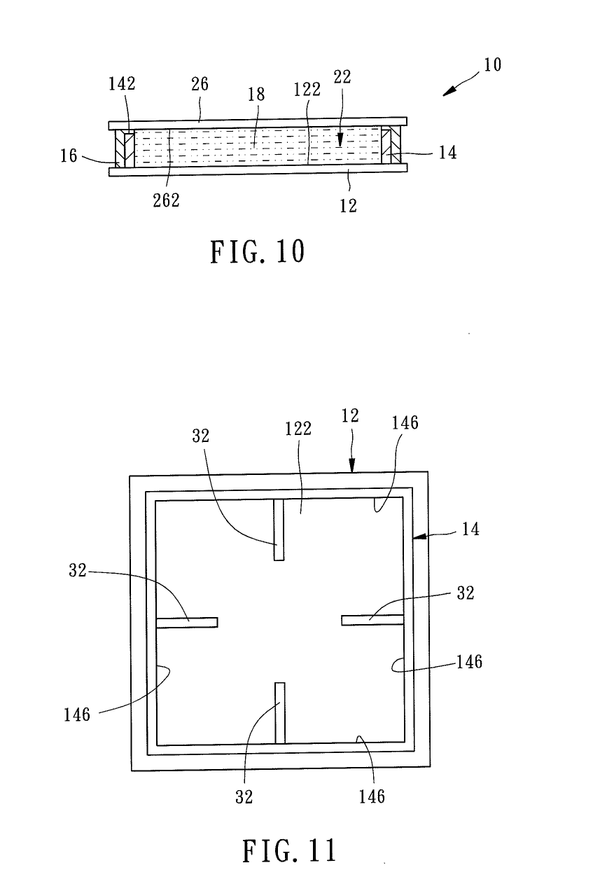

At first, the applicant must explain that, in the following embodiments and annexed drawings, like reference numbers represent like components or structural features. Secondly, when referring to “mounting one component at another” means a component is directly attached to a second component, or the first component is indirectly attached the second component with one or more other components set therebetween. When referring to “directly” attaching one component to another component means no any other component set between these two components. Referring to FIGS. 1-10, an energy storage device fabrication method in accordance with a first embodiment for making an energy storage device 10 (see FIG. 10) is shown. This energy storage device fabrication method comprises the steps of a) through e).

In step a), as shown in FIG. 1, provide a first plate electrode 12 from titanium or any other metal or non-metal material capable of undergoing an oxidation-reduction reaction with the electrolyte solution. As shown in FIGS. 2 and 3, fixedly mount a frame shell 14 at a top wall 122 of the first plate electrode 12 by, for example, coating the top wall 122 of the first plate electrode 12 with a photocurable ink and enabling the applied photocurable ink to cure under the radiation of light.

In this embodiment, the inner and outer perimeters of the frame shell 14 are rectangular; the frame shell 14 defines a top wall 142, four outer perimeter walls 144, and four inner perimeter walls 146. However, the configuration and formation of the frame shell 14 are not limited to the above example. Any other measure can be employed to fixedly form a frame shell 14 having a closed outer contour at the top wall 122 of the first plate electrode 12.

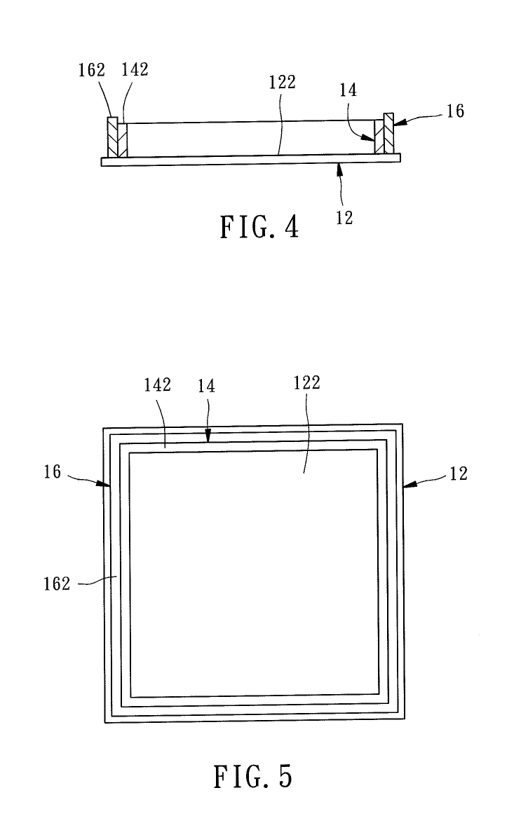

In step b), as shown in FIGS. 4 and 5, fixedly mount a glue frame 16 around the frame shell 14 at the top wall 122 of the first plate electrode 12 in such a manner that the distance between a top wall 162 of the glue frame 16 and the top wall 122 of the first plate electrode 12 is greater than the distance between the top wall 142 of the frame shell 14 and the top wall 122 of the first plate electrode 12. The glue frame 16 is preferably made of thermoplastic resin with good acid and alkali resistance and excellent adhesion and seal strength.

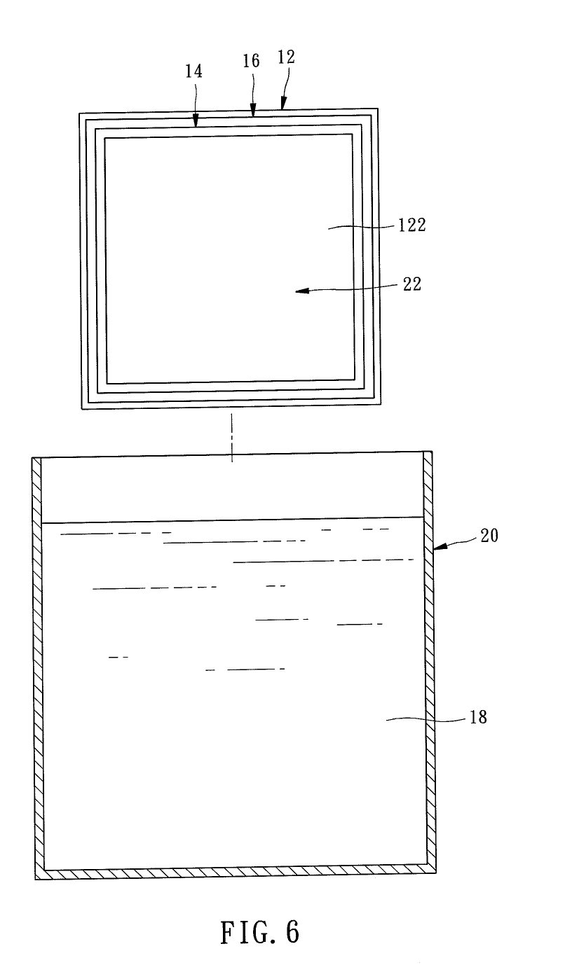

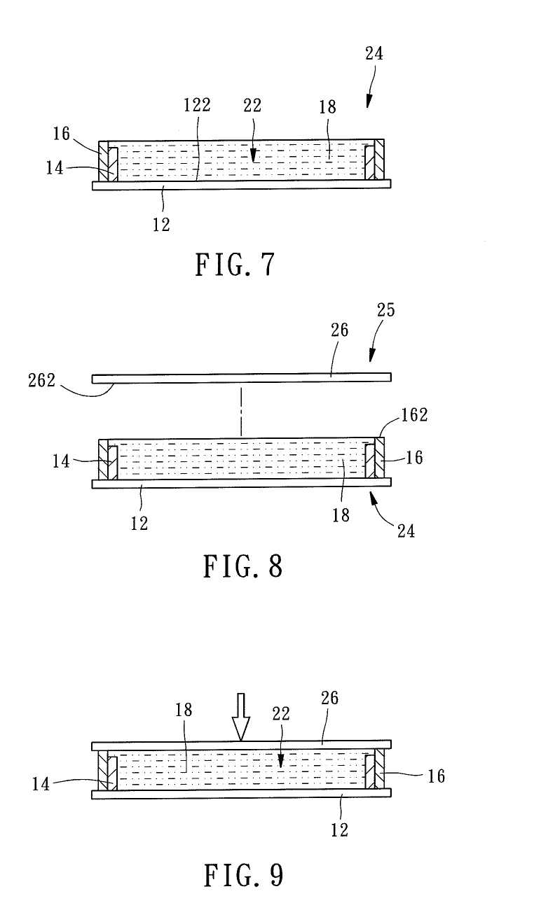

In step c), as shown in FIG. 6, position the first plate electrode 12 with the attached frame shell 14 and glue frame 16 in an electrolyte solution 18 in a container 20 under a vacuum environment, enabling an accommodation chamber 22 surrounded by the glue frame 16, the frame shell 14 and the top wall 122 of the first plate electrode 12 to be filled up by the electrode solution 18, whereby the first plate electrode 12, the frame shell 14, the glue frame 16 and the electrolyte solution 18 constitute a first unit 24 (see FIG. 7).

An ultrasonic device (not shown) can be set in the container 20 to generate ultrasonic waves in oscillating the electrolyte solution 18 during this step, enabling the electrolyte solution 18 to be easily filled up the accommodation chamber 22 with no significant amount of residual air in the accommodation chamber 22.

This step is mainly to fill the electrolyte solution 18 in the accommodation chamber 22. The described method is not a limitation. For example, the electrolyte solution 18 can be poured into the accommodation chamber 22.

In step d), as shown in FIG. 8, a second unit 25 is mounted at the top wall 162 of the glue frame 16. In this second embodiment, the second unit 25 simply comprises a second plate electrode 26 that can be prepared from titanium or any other metal or non-metal material capable of undergoing an oxidation-reduction reaction with the electrolyte solution.

In step e), use a heating equipment (not shown) to heat the glue frame 16 under a vacuum environment to a softened status, and then press the second plate electrode 26 against the first plate electrode 12 (see FIG. 9) to let the softened glue frame 16 and the second plate electrode 26 be bonded together and a part of the softened glue frame 16 be coated on the top wall 142 of the frame shell 14, thereby bonding the frame shell 14 and the second plate electrode 26 together (see FIG. 10). During this process, the distance between the first plate electrode 12 and the second plate electrode 26 will be shortened and the volume of the accommodation chamber 22 will be reduced, causing residual air in the accommodation chamber 22 and excessive electrolyte solution 18 to be discharged outside the glue frame 16. Thus, the electrolyte solution 18 sealed in the energy storage device 10 will not contain much air to affect its performance. Therefore, the above-described energy storage device fabrication method can greatly improve the manufacturing yield rate of the energy storage device 10.

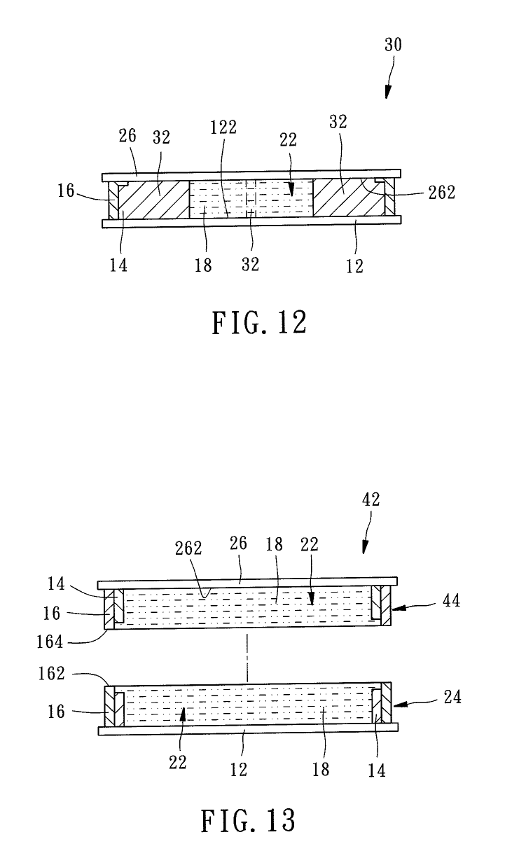

Referring to FIGS. 11 and 12, an energy storage device 30 made in accordance with a second embodiment of the present invention is shown. When compared to the energy storage device 10 provided in accordance with the first embodiment of the present invention, the energy storage device 30 of this second embodiment further comprises four support members 32 fixedly mounted at the top wall 122 of the first plate electrode 12 and disposed in the accommodation chamber 22, as shown in FIG. 11. The support members 32 and the frame shell 14 can be integrally made in one piece, i.e., the support members 32 can be prepared from a photocurable ink. Thus, the support members 32 can provide support between the first plate electrode 12 and the second plate electrode 26 to enhance the structural strength of the energy storage device 30.

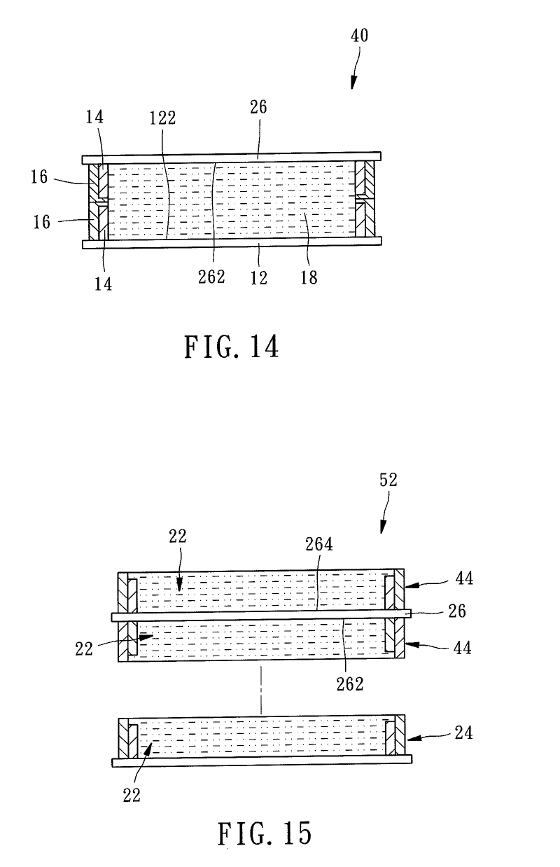

Referring to FIGS. 13 and 14, an energy storage device 40 made in accordance with a third embodiment of the present invention is shown. When compared to the method for the fabrication of the energy storage device 10 in accordance with the first embodiment of the present invention, the method for the fabrication of the energy storage device 40 in accordance with this third embodiment of the present invention is characterized in that: the second unit 42 of the energy storage device 40 prepared during step d), in addition to the second plate electrode 26, further comprises an attached structure 44 at a bottom wall 262 of the second plate electrode 26. Therefore, the second unit 42 has a structure same as the first unit 24. In other words, the attached structure 44 comprises a frame shell 14 and a glue frame 16 fixedly mounted at the bottom wall 262 of the second plate electrode 26, and the accommodation chamber 22 is filled up with an electrolyte solution 18.

During step d), stack the bottom wall 164 of the glue frame 16 of the second unit 42 on the top wall 162 of the glue frame 16 of the first unit 24. Due to the facts that the electrolyte solution 18 is composed of very small molecules, the surfaces of the frame shell 14 and the glue frame 16 curve up and down, and the accommodation chamber 22 has a small height, the electrolyte solution 18 can be retained in the accommodation chamber 22 even when the accommodation chamber 22 of the second unit 42 faces down.

During step e), soften the glue frame 16 of the first unit 24 and the glue frame 16 of the second unit 25 and then bond the two glue frames 16 together, thereby forming the energy storage device 40, as shown in FIG. 14. Thus, a relatively greater amount of the electrolyte solution 18 can be sealed between the first plate electrode 12 and the second plate electrode 26 for storing more electrical energy. Referring to FIGS. 10, 12 and 14, the energy storage devices 10;30;40 made according to the aforesaid various embodiments simply comprise two plate electrodes 12;26 and one layer of electrolyte solution 18, and charging/discharging in the energy storage devices 10;30;40 occurs at the interfaces between the plate electrodes 12;26 and the electrolyte solution 18, i.e., between the top wall 122 of the first plate electrode 12 and the electrolyte solution 18 and between the bottom wall 262 of the second plate electrode 26 and the electrolyte solution 18. In actual application, the fabrication method can fabricate energy storage devices with multiple layers of plate electrodes and electrolyte solution so that the energy storage devices can provide a large number of interfaces to perform charging and discharging, thereby improving the charging efficiency and increasing the energy storage capacity.

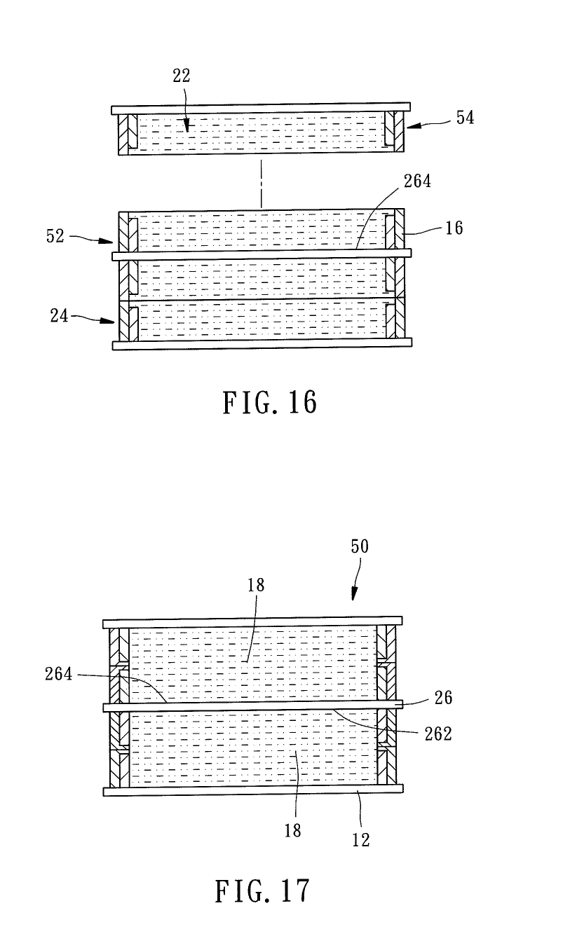

For example, in accordance with a fourth embodiment of the present invention, as shown in FIGS. 15-17, an energy storage device 50 with two layers of electrolyte solution 18 is shown. During step d) of the fabrication method in accordance with this fourth embodiment, two attached structures 44 are respectively provided at the bottom wall 262 and top wall 264 of the second plate electrode 26 of the second unit 52. Thus, in addition to the layer of electrolyte solution 18 between the bottom wall 262 of the second plate electrode 26 and the first plate electrode 12, the energy storage device 50 further comprises a third unit 54 stacked on the glue frame 16 at the top wall 264 of the second plate electrode 26, and an additional layer of electrolyte solution 18 at the top side of the top wall 264. In this embodiment, the third unit 54 is same as the second unit 42 of the aforesaid third embodiment (see FIG. 13). However, this third unit 54 can be made same as the second unit 25 of the aforesaid first embodiment (see FIG. 8), i.e., simply comprising one plate electrode. Thus, the energy storage device 90 provides three plate electrodes and four charging/discharging interfaces, increasing the charging efficiency and the energy storage capacity.

One can imagine that an energy storage device with two layers of electrolyte solution 18 can be made subject to the fabrication method of the present invention simply by: stacking an intermediate unit (similar to the structure of the first unit 24 or second unit 52) on the first unit 24 and then stacking up an enclosed unit (similar to the structure of the second unit 25 or 42) during step d).

Even though more intermediate units can be arranged between the first unit 24 and the aforesaid enclosed unit to produce an energy storage device having multiple layers of electrolyte solution 18 to provide multiple charging/discharging interfaces, enhancing the charging efficiency and increasing the energy storage capacity. It is worth mentioning that, in each of the aforesaid various embodiments, support members 32 disclosed in the second embodiment can be provided inside the accommodation chamber 22 to enhance the structural strength of the energy storage device. The number and configuration of the support members are unlimited, and the support members are not necessarily connected with the frame shell in integrity. The support members can simply be fixedly provided at the plate electrode in the accommodation chamber 22.

Further, it is worth mentioning that in actual application, the energy storage device fabrication of the present invention can fabricate a large amount of energy storage components that share the plate electrodes. After the aforesaid steps, these plate electrodes are properly cut off, separating the energy storage components. However, the technical features of the present invention are focused on the steps prior to this cutting procedure, i.e., the aforesaid steps a) through e), and therefore the annexed drawings and the above described embodiments simply show and describe one single energy storage device for understanding of the spirit and scope of the invention. Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An energy storage device fabrication method, comprising the steps of:
a) fixedly mounting a frame shell at a top wall of a first plate electrode;
b) fixedly mounting a glue frame at the top wall of said first plate electrode around said frame shell in such a manner that the distance between a top wall of said glue frame and the top wall of said first plate electrode is greater than the distance between a top wall of said frame shell and the top wall of said first plate electrode;
c) filling an electrolyte solution in an accommodation chamber defined by said glue frame, said frame shell and the top wall of said first plate member under a vacuum environment, whereby said first plate electrode, said frame shell, said glue frame and said electrolyte solution constitute a first unit;
d) mounting a second unit at the top wall of said glue frame, said second unit comprising a second plate electrode; and
e) applying a pressure to said first unit and said second unit to bond said second unit to said glue frame of said first unit under a vacuum environment to seal said electrolyte solution in between said first plate electrode and said second plate electrode.

2. The energy storage device fabrication method as claimed in claim 1, wherein said step c) of filling an electrolyte solution in an accommodation chamber is to dip said first plate electrode with said frame shell and said glue frame in a container holding said electrolyte solution to let said electrolyte solution fill up said accommodation chamber.

3. The energy storage device fabrication method as claimed in claim 2, wherein said step c) further comprising a sub step of vibrating said electrolyte solution with ultrasonic waves.

4. The energy storage device fabrication method as claimed in claim 1, wherein said first plate electrode comprises at least one support member fixedly arranged at the top wall thereof and suspending in said accommodation chamber.

5. The energy storage device fabrication method as claimed in claim 4, wherein said frame shell comprises a plurality of inner perimeter walls disposed in said accommodation chamber, each said inner perimeter having one said support member protruded therefrom.

6. The energy storage device fabrication method as claimed in claim 1, wherein said second unit further comprises an attached structure, said attached structure comprising a frame shell fixedly mounted at a bottom wall of said second plate electrode, a glue frame fixedly mounted at the bottom wall of said second plate electrode outside the frame shell of said attached structure in such a manner that the distance between a top wall of the glue frame of said attached structure and the top wall of said first plate electrode is greater than the distance between a top wall of the frame shell of said attached structure and the top wall of said first plate electrode, and an electrolyte solution filled in an accommodation chamber defined by the glue frame and frame shell of said attached structure and the bottom wall of said second electrode; said step d) is to stack the glue frame of said second unit on the glue frame of said first unit; said step e) is to soften the glue frame of said first unit and the glue frame of said second unit and to have these two glue frames be bonded together.

7. The energy storage device fabrication method as claimed in claim 6, wherein said second unit further comprises another said attached structure mounted at a top wall of said second plate electrode.

8. The energy storage device fabrication method as claimed in claim 6, wherein the attached structure of said second unit further comprises at least one support member disposed in said accommodation chamber and fixedly mounted at said second plate electrode.

9. The energy storage device fabrication method as claimed in claim 8, wherein the at least one support member of the attached structure of said second unit is integrally connected with the frame shell thereof.

10. The energy storage device fabrication method as claimed in claim 9, wherein the frame shell of the attached structure of said second unit comprises a plurality of inner perimeter walls disposed in the accommodation chamber of the attached structure of said second unit, each said inner perimeter having one said support member protruded therefrom.
